(19) United States
(12) Patent Application Publication
(10) Pub. No.: US 2005/0219427 A1
(43) Pub. Date: Oct. 6, 2005

(54) Television receiver

(75) Inventor: Shigeo Akazawa, Tokyo (JP)

Correspondence Address: MCGINN & GIBB, PLLC, 8321 OLD COURTHOUSE ROAD, SUITE 200, VIENNA, VA, 22182-3817, US

(73) Assignee: Clarion Co., Ltd., Tokyo (JP)

(21) Appl. No.: 11/088,996

(22) Filed: Mar. 24, 2005

(30) Foreign Application Priority Data
Mar. 30, 2004 (JP) P2004-98023

(51) Int. Cl. H04N 5/64

(52) U.S. Cl. 348/839; 348/731

(57) ABSTRACT

A television receiver including at least one television receiver body having a display unit for displaying pictures on the basis of video signals, and a tuner unit which is provided separately from the television receiver body and receiving television signals of plural channels. The tuner unit comprises a television receiving portion for outputting the video and audio signals corresponding to a television signal of any one channel of the plural channels and a tuner side transmitting portion for converting input video and audio signals to transmission data and wirelessly transmitting the transmission data, and the television receiver body has a body side receiving portion for converting the received transmission data to the video and audio signals.

### BACKGROUND OF THE INVENTION

1. Field of the Invention

The present invention relates to a television receiver having a television receiver body.

2. Description of the Related Art

There is know a television receiver having a tuner unit installed in the main body of the television receiver (hereinafter referred to as a television receiver body) having a display unit (for example, JP-A-5-252069).

The television receiver body is equipped with an antenna terminal, and it can receive broadcasting television signals by connecting the antenna terminal of the television receiver body to an external antenna terminal provided on an indoor wall surface through an antenna cable, for example.

With the television receiver described above, when the arrangement of the television receiver body itself is changed, the length of the antenna cable must be changed or it is required to carry out a work of laying down the antenna cable so that the antenna cable is prevented from forming an obstacle if the distance between the external antenna terminal and the antenna terminal of the television receiver body is increased. Therefore, the television receiver has a problem that the degree of freedom in the arrangement of the television receiver body is low.

### SUMMARY OF THE INVENTION

Therefore, an object of the present invention is to solve the above problem and provide a television receiver in which the degree of freedom in the arrangement of the television receiver body is enhanced.

In order to attain the above object, there is provided a television receiver equipped with a television receiver body having a display unit for displaying pictures on the basis of video signals, and a tuner unit which is provided separately from the television receiver body and receiving television signals of plural channels, wherein the tuner unit comprises a television receiving portion for outputting the video and audio signals corresponding to a television signal of any one channel of the plural channels and a tuner side transmitting portion for converting input video and audio signals to transmission data and wirelessly transmitting the transmission data, and the television receiver body has a body side receiving portion for converting the received transmission data to the video and audio signals.

In the above television receiver, the television receiver body may have a body side transmitting portion for wirelessly transmitting control data for specifying any one channel of the plural channels, the tuner unit may have a tuner side receiving portion for receiving the control data and the television receiving portion outputs the video and audio signals of the channel corresponding to the control data.

Furthermore, in the above television receiver, the body side transmitting portion wirelessly may transmit acknowledgment data concerning two-way broadcast to the tuner side receiving portion, and the tuner unit may have an external interface portion for transmitting the acknowledgement data through a public line to a broadcast station.

Still furthermore, in the above television receiver, the communication between the tuner side transmitting portion and the body side receiving portion and the communication between the body side transmitting portion and the tuner side receiving portion may be carried out by using electric waves.

Still furthermore, in the above television receiver, the communication between the tuner side transmitting portion and the body side receiving portion and the communication between the body side transmitting portion and the tuner side receiving portion may be performed by using light.

Still furthermore, the above television receiver may have a plurality of television receiver bodies, and the tuner side transmitting portion may wirelessly transmit the same transmission data to the plural television receiver bodies.

Still furthermore, in the above television receiver, the tuner unit may be equipped with an antenna terminal which is connected through an antenna cable to an external antenna terminal connected to a television signal receiving antenna so that television signals of the plural channels are input through the antenna terminal to the tuner unit.

According to the present invention, the degree of freedom in the arrangement of the television receiver body is enhanced.

### BRIEF DESCRIPTION OF THE DRAWINGS

FIG. 1 is a block diagram showing the schematic electrical construction of a television receiver according to a first embodiment of the present invention;

FIG. 2 is a diagram showing a television receiver according to a second embodiment of the present invention; and

FIG. 3 is a block diagram showing the schematic electrical construction of a television receiver according to a third embodiment of the present invention.

### DETAILED DESCRIPTION OF THE PREFERRED EMBODIMENTS

Preferred embodiments according to the present invention will be described hereunder with reference to the accompanying drawings.

### [1] First Embodiment

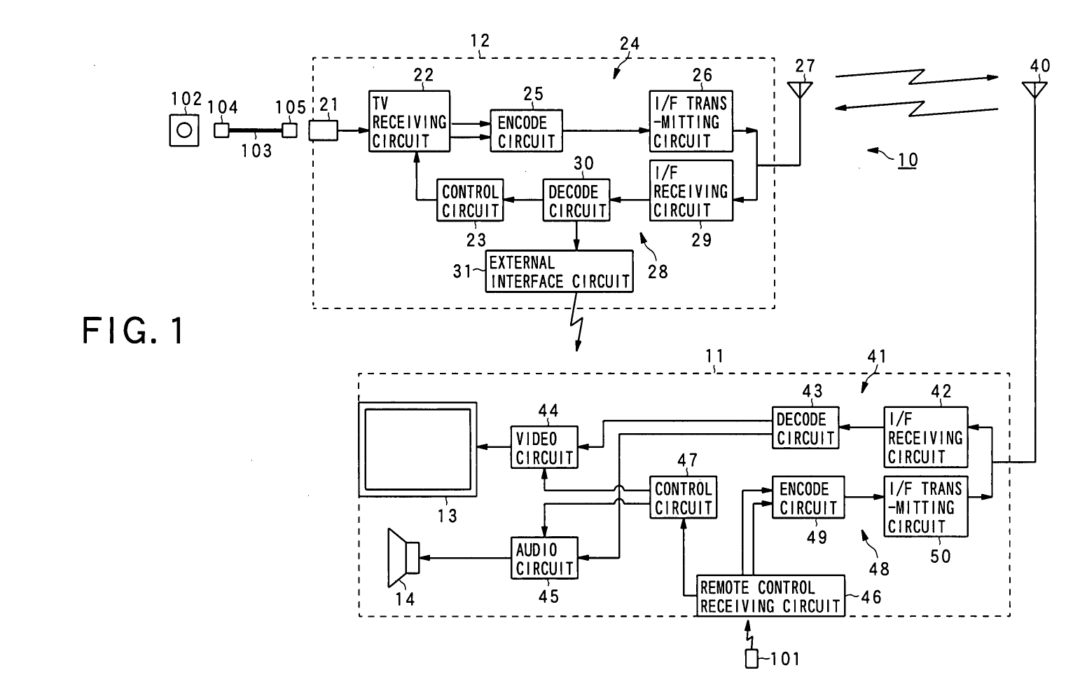

FIG. 1 is a block diagram showing the schematic electric construction of a television receiver 10 according to a first embodiment.

The television receiver 10 is equipped with a television receiver body 11 and a tuner unit 12 which is provided separately from the television receiver body 11.

The television receiver body 11 has a display unit 13 such as LCD or the like and a speaker 14, and pictures are displayed on the display unit 13 while sounds are output from the speaker 14. The television receiver 10 is adapted to terrestrial digital television broadcast. The television receiver 10 can perform two-way broadcast, and it is designed so that acknowledgement data can be transmitted to a broadcast station by user's operation of a remote controller 101.

The television receiver body 11 and the tuner unit 12 are set up indoors. An external antenna terminal 102 connected to a television signal receiving antenna (not shown) disposed outdoors is formed on an indoor wall surface. Accordingly, the television receiver 10 can achieve television signals of plural channels broadcasted from broadcast stations through the external antenna terminal.

The tuner unit 12 is provided with an antenna terminal 21, and the external antenna terminal 102 and the antenna terminal 21 of the tuner unit 12 are connected to each other through a coaxial cable 103 as an antenna cable. Specifically, antenna plugs 104 and 105 to be connected to the antenna terminals 21 and 102 are formed at both the ends of the coaxial cable 103. The antenna plug 104 at one side of the coaxial cable 103 is connected to the external antenna terminal 102, and the antenna plug 105 at the other side is connected to the antenna terminal 21. Accordingly, the tuner unit 12 receives television signals of plural channels through the antenna terminal 21.

The tuner unit 12 has a television receiving circuit (television receiving portion) 22 for outputting video and audio signals corresponding to a television signal of any one channel of the television signals of the plural channels which are input from the antenna terminal 21.

The television receiving circuit 22 is controlled by a control circuit 23. Specifically, the control circuit 23 outputs a control signal to the television receiving circuit 22 when control data for specifying a channel is input to the control circuit 23. The television receiving circuit 22 receives the television signal of the channel corresponding to the control data on the basis of the input control signal, demodulates the television signal thus received and then outputs video and audio signals to a tuner side transmitting portion 24. Here, the control data contains data for specifying the respective modes such as stereo broadcasting, sound multiplex broadcasting, bilingual broadcasting, teletext broadcasting, data broadcasting, etc. The television receiving circuit 22 demodulates the television signal corresponding to each mode and outputs the video and audio signals to the tuner side transmitting portion 24.

The tuner side transmitting portion 24 converts the video and audio signals thus input to transmission data and wirelessly transmits the transmission data thus converted through the antenna 27. The tuner side transmitting portion 24 has an encode circuit 25 and an I/F transmitting circuit 26. The encode circuit 25 converts (encodes) the input video and audio signals to the transmission data to transmit the video and audio signals to the television receiver body 11, and then outputs the transmission data to the I/F transmitting circuit 26. The encode circuit 25 may convert the video signal to compressed data of the MPEG1, MPEG2 or MPEG4 format. The I/F transmitting circuit 26 demodulates the input transmission data to a signal that can be transmitted through the antenna 27, and transmits the signal indicating the transmission data through the antenna 27 with electric waves. That is, the tuner side transmitting portion 24 converts the video and audio signals to the transmission data to wirelessly transmit the video and audio signals to the television receiver body 11. Accordingly, degradation of the image quality of pictures can be reduced.

The television receiver body 11 has a body side receiving portion 41 for converting received transmission data to video and audio signals. The body side receiving portion 41 has an I/F receiving circuit 42 and a decode circuit 43. The I/F receiving circuit 42 receives and demodulates the signal indicating the transmission data through an antenna 40, and outputs the transmission signal to a decode circuit 43. The decode circuit 43 converts (decodes) the input transmission data to the video and audio signals, and outputs the video and audio signals to a video circuit 44 and an audio circuit 45, respectively.

The video circuit 44 controls the display unit 13 to display pictures on the basis of the input video signal. That is, the display unit 13 displays pictures based on the video signal. The audio circuit 45 controls the speaker 14 to output sounds on the basis of the audio signal.

The television receiver body 11 has a remote control receiving circuit 46 for receiving from a remote controller 101 optical signals indicating various kinds of signals such as a video and audio control signal for changing the image quality or sound quality, a channel control signal for specifying a channel, an acknowledgement signal concerning two-way broadcasting, etc.

The remote control receiving circuit 46 outputs the video and audio control signal to the control circuit 47. The control circuit 47 controls the video circuit 44 or the audio circuit 45 on the basis of the input video and audio control signal. Specifically, the control circuit 47 outputs the video control signal to the video circuit 44, and also outputs the audio control signal to the audio circuit 45. The video circuit 44 changes the image quality of pictures to be displayed on the display unit 13 on the basis of the input video control signal. The audio circuit 45 changes sounds to be output from the speaker 14 on the basis of the input audio control signal.

The television receiver body 11 has a body side transmitting portion 48 for converting the channel control signal to the control data and then wirelessly transmitting the control data through the antenna 40 and also converting the acknowledgement signal to acknowledgement data and then wirelessly transmitting it through the antenna 40. That is, when receiving an optical signal indicating the channel control signal from the remote controller 101, the remote control receiving circuit 46 demodulates the optical signal and outputs the channel control signal to the body side transmitting portion 48. When receiving an optical signal indicating the acknowledgment signal, the remote control receiving circuit 46 demodulates the optical signal and outputs the acknowledgement signal to the body side transmitting portion 48.

The body side transmitting portion 48 converts the input channel control signal to the control data, and transmits the control data through the antenna 40 with electric waves. Furthermore, it converts the input acknowledgment signal to acknowledgment data and transmits the acknowledgement data through the antenna 40 with electric waves. Specifically, the body side transmitting portion 48 has an encode circuit 49 and an I/F transmitting circuit 50. The encode circuit 49 converts the input channel control signal to the control data and outputs it to the I/F transmitting circuit 50, and also it converts the input acknowledgment signal to the acknowledgment data and outputs it to the I/F transmitting circuit 50. The I/F transmitting circuit 50 modulates the input control data or acknowledgment data to a signal that can be transmitted through the antenna 40, and transmits a signal indicating the control data or the acknowledgment data through the antenna 40.

The tuner unit 12 has a tuner side receiving portion 28 for receiving the signal indicating the control data or the acknowledgement data through an antenna 27. The tuner side receiving portion 28 has an I/F receiving circuit 29 and a decode circuit 30. The I/F receiving circuit 29 receives and demodulates the signal indicating the control data or the acknowledgement data through the antenna 27, and outputs the control data or the acknowledgment data to the decode circuit 30. The decode circuit 30 outputs the control data to the control circuit 23 when receiving the control data. As described above, the control circuit 23 outputs the control signal to the television receiving circuit 22, and the television receiving circuit 22 outputs the video and audio signals of the channel corresponding to the control data to the encode circuit 25 on the basis of the control signal of the control circuit 23.

That is, when a user selects a channel by using the remote controller 101, the control data are transmitted from the television receiver body 11 to the tuner unit 12, and the transmission data indicating the video and audio signals of the channel corresponding to the control data are transmitted from the tuner unit 12 to the television receiving body 11.

Furthermore, the decode circuit 30 outputs the acknowledgment data to an external interface circuit (external interface portion) 31 when receiving the acknowledgement data. The external interface circuit 31 transmits the input acknowledgement data through a public line.

In the first embodiment, the tuner unit 12 connected to the external antenna terminal 102 through the coaxial cable 103 is provided separately from the television receiver body 11, and the tuner unit 12 wirelessly transmits the video and audio signals to the television receiver body 11. Therefore, it is unnecessary to connect the television receiver body 11 and the external antenna terminal 102 through the coaxial cable, and thus a cumbersome wiring work can be avoided. In addition, the degree of freedom in arrangement of the television receiver body 11. Furthermore, even when the arrangement of the television receiver body 11 is changed, it is not required to change the setup position of the tuner unit 12 or it is merely required to slightly change the setup position of the tuner unit 12. Therefore, it is possible to minimize the distance between the external antenna terminal 102 and the antenna terminal 21 of the tuner unit 12, and it is not required to change the length of the coaxial cable 103.

Furthermore, according to the first embodiment, the transmission data are transmitted with electric waves from the tuner unit 12. Therefore, even when there is an obstacle such as furniture or the like, the transmission data transmitted from the tuner unit 12 can be received by the television receiver body 11. Accordingly, the degree of freedom in the arrangement of the television receiver body 11 in a room can be further enhanced.

### [2] Second Embodiment

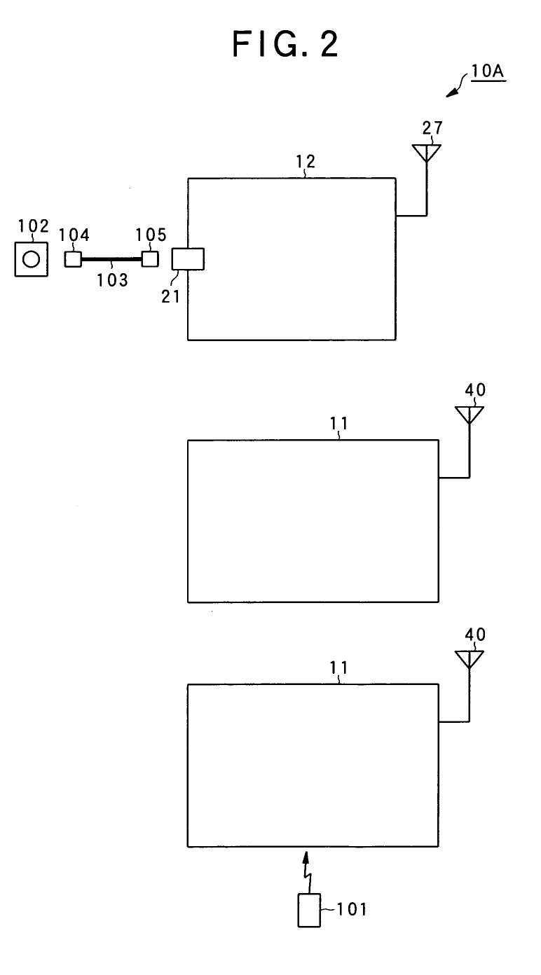

FIG. 2 is a diagram showing a television receiver 10A according to a second embodiment. This embodiment is different from the first embodiment in that the television receiver 10A has plural television receiver bodies 11. In the second embodiment, the same parts as the first embodiment are represented by the same reference numerals, and the description thereof is omitted.

As shown in FIG. 2, the television receiver 10A is equipped with one tuner unit 12 and plural (for example, two) television receiver bodies 11.

The tuner side transmitting portion of the tuner unit 12 (see FIG. 1) wirelessly transmits the same transmission data to the plural television receiver bodies 11 within a transmissible area. Accordingly, the body side receiving portion 41 (see FIG. 1) of each television receiver body 11 receives transmission data and converts the transmission data to video and audio signals. The display unit 13 (see FIG. 1) of each television receiver body 11 displays the same pictures, and the speaker (see FIG. 1) of each television receiver body 11 outputs the same sounds. Accordingly, the transmission data indicating the video and audio signals can be simultaneously transmitted to the plural television receiver bodies 11 by using one tuner unit 12, and it is unnecessary to connect the external antenna terminal 102 to the plural television receiver bodies 11 through coaxial cables, so that the degree of freedom in arrangement of the plural television receiver bodies 11 can be enhanced.

Furthermore, when an optical signal for specifying a channel is received from the remote controller 101 by the remote control receiving circuit 46 (see FIG. 1) of any one television receiver body 11, the body side transmitting portion 48 (see FIG. 1) of the television receiver body 11 concerned transmits the control data with electric waves. The tuner unit 12 receiving the control data transmits the transmission data corresponding to a specified channel to plural television receiver bodies 11 within a transmissible area. Accordingly, the same pictures corresponding to the specified channel are displayed on the display units 13 of the respective television receiver bodies 11 while the same sounds corresponding to the specified channel are output from the speakers of the respective television receiver bodies 11.

That is, when a user instructs any one television receiver body 11 to select a channel by using the remote controller 101, the pictures corresponding to the selected channel are displayed on the display units 13 of all the television receiver bodies 11, and the sounds corresponding to the selected channel are output from the speakers 14 of all the television receiver bodies 11.

Accordingly, the pictures corresponding to the specified channel can be simultaneously displayed on all the television receiver bodies 11, and also the sounds corresponding to the specified channel can be simultaneously output, so that the user's operability can be enhanced.

### [3] Third Embodiment

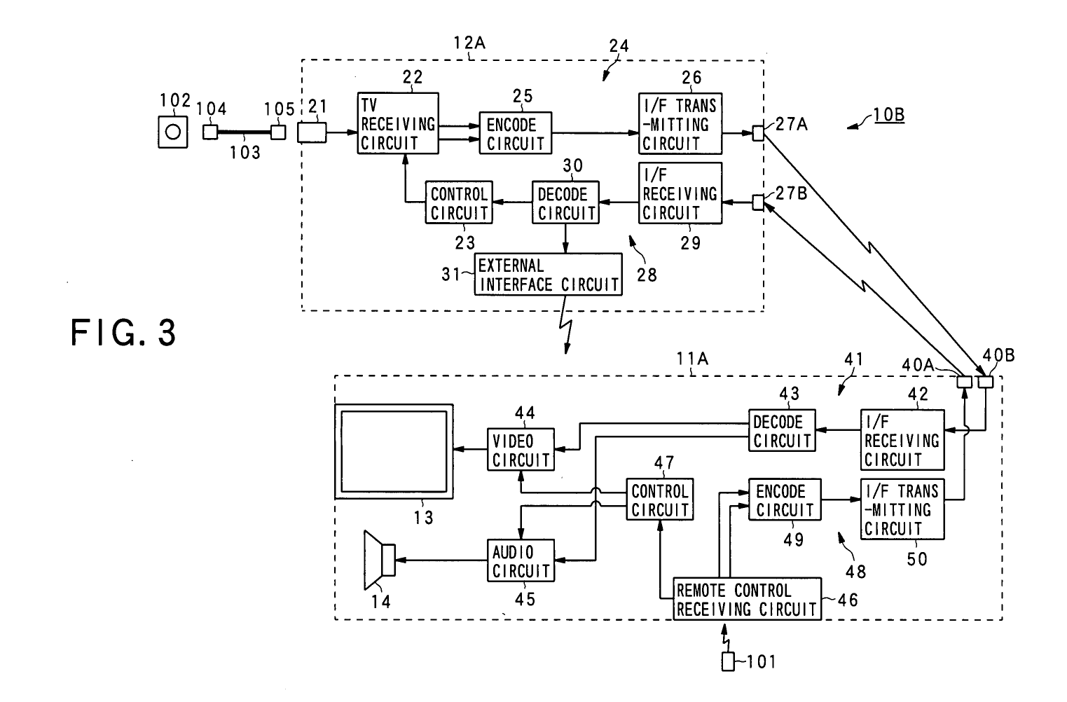

FIG. 3 is a block diagram showing the schematic electric construction of a television receiver 10B according to a third embodiment. The third embodiment is different from the first and second embodiments in that the communication between the tuner side transmitting portion 24 and the body side receiving portion 41 and the communication between the body side transmitting portion 48 and the tuner side receiving portion 28 are performed by using light. In the third embodiment, the same parts as the first embodiment are represented by the same reference numerals, and the description thereof is omitted.

As shown in FIG. 3, in the third embodiment, the tuner unit 12A has a light emitting portion 27A and a light receiving portion 27B in place of the antenna 27 (FIG. 1) of the first embodiment. Furthermore, as shown in FIG. 3, the television receiver body 11A has a light emitting portion 40A and a light receiving portion 40B in place of the antenna 40 (FIG. 1) of the first embodiment.

The light emitting portion 27A of the tuner unit 12A converts an electrical signal indicating transmission data output from the I/F transmitting circuit 26 to an optical signal, and transmits the optical signal to the television receiver body 11A. The light receiving portion 40B of the television receiving body 11A converts the received optical signal indicating the transmission data to an electrical signal and outputs it to the I/F receiving circuit 42.

Furthermore, the light emitting portion 40A of the television receiving body 11A converts to an optical signal the electrical signal indicating the control data or acknowledgement data output from the I/F transmitting circuit 50, and transmits the optical signal to the tuner unit 12A. The light receiving portion 27B of the tuner unit 12A converts to an electrical signal the optical signal indicating the control data or the acknowledgement data, and outputs it to the I/F receiving circuit 29.

According to the third embodiment, the television receiver body 11A and the tuner unit 12A must be arranged so that no obstacle for shielding light is located between the television receiver body 11A and the tuner unit 12A. As in the case of the first embodiment, it is not required to wire the coaxial cable to the television receiver body 11A, and thus the cumbersome wiring work can be avoided. In addition, the degree of freedom in the arrangement of the television receiver body 11A in a room can be enhanced.

The present invention is not limited to the above embodiments, and various modifications may be made without departing from the subject matter of the present invention.

For example, in the above embodiments, the channel is specified by operating the remote controller 101. However, the present invention is not limited to this mode. For example, an operating portion for specifying the channel may be provided to the tuner unit, or an operating portion for specifying the channel may be provided separately from the tuner unit so as to be connected to the tuner unit in a wired or wireless style.

1. A television receiver, comprising:
at least one television receiver body having a display unit for displaying pictures on the basis of video signals; and
a tuner unit which is provided separately from the television receiver body and receiving television signals of plural channels, wherein the tuner unit comprises a television receiving portion for outputting the video and audio signals corresponding to a television signal of any one channel of the plural channels and a tuner side transmitting portion for converting input video and audio signals to transmission data and wirelessly transmitting the transmission data, and the television receiver body has a body side receiving portion for converting the received transmission data to the video and audio signals.

2. The television receiver according to claim 1, wherein the television receiver body has a body side transmitting portion for wirelessly transmitting control data for specifying any one channel of the plural channels, the tuner unit has a tuner side receiving portion for receiving the control data and the television receiving portion outputs the video and audio signals of the channel corresponding to the control data.

3. The television receiver according to claim 2, wherein the body side transmitting portion wirelessly transmits acknowledgment data concerning two-way broadcast to the tuner side receiving portion, and the tuner unit has an external interface portion for transmitting the acknowledgement data through a public line to a broadcast station.

4. The television receiver according to claim 2, wherein the communication between the tuner side transmitting portion and the body side receiving portion and the communication between the body side transmitting portion and the tuner side receiving portion is carried out by using electric waves.

5. The television receiver according to claim 2, wherein the communication between the tuner side transmitting portion and the body side receiving portion and the communication between the body side transmitting portion and the tuner side receiving portion is performed by using light.

6. The television receiver according to claim 1, wherein the above television receiver has a plurality of television receiver bodies, and the tuner side transmitting portion wirelessly transmits the same transmission data to the plural television receiver bodies.

7. The television receiver according to claim 1, wherein the tuner unit is equipped with an antenna terminal which is connected through an antenna cable to an external antenna terminal connected to a television signal receiving antenna so that television signals of the plural channels are input through the antenna terminal to the tuner unit.
